(19) United States
(12) Patent Application Publication
(10) Pub. No.: US 2023/0289919 A1
(43) Pub. Date: Sep. 14, 2023

(54) VIDEO STREAM REFINEMENT FOR DYNAMIC SCENES

(71) Applicant: Microsoft Technology Licensing, LLC, Redmond, WA (US)

(72) Inventors: Sunando SENGUPTA, Reading (GB); John G A WEISS, Seattle, WA (US); Luming LIANG, Redmond, WA (US); Ilya D. ZHARKOV, Sammamish, WA (US); Eric CW SOMMERLADE, Oxford (GB)

(73) Assignee: Microsoft Technology Licensing, LLC, Redmond, WA (US)

(21) Appl. No.: 17/693,056

(22) Filed: Mar. 11, 2022

(51) Int. Cl. G06T 3/40; G06V 10/25; G06T 7/246

(52) U.S. Cl. CPC G06T 3/40; G06V 10/25; G06T 7/246; G06T 2207/20081

(57) ABSTRACT

Aspects of the present disclosure relate to video stream refinement for a dynamic scene. In examples, a system is provided that includes at least one processor, and memory storing instructions that, when executed by the at least one processor, causes the system to perform a set of operations. The set of operations include receiving an input video stream, identifying, within the input video stream, a frame portion containing features of interest, enlarging the frame portion containing the features of interest, enhancing the frame portion of the input video stream to increase fidelity within the frame portion, and displaying the enhanced frame portion.

### BACKGROUND

A user of a computing device may desire for a video stream display to focus on a subject of interest. For example, the subject of interest may be the user themselves on a video call, and the method of focus may be digitally zooming in on the subject of interest. However, digitally zooming in on a subject of interest may cause the subject of interest to become blurry, and to lose fidelity on the video stream.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to methods, systems, and media for enhancing a portion of a video stream that contains a user who may be moving within the video stream.

In some aspects of the present disclosure, a system is provided. The system includes at least one process, and memory storing instructions that, when executed by the at least one processor, causes the system to perform a set of operations. The set of operations include obtaining an input video stream. The set of operations further include identifying, within the input video stream, a frame portion containing a subject of interest. The set of operations further include enlarging the frame portion containing the subject of interest. The set of operations further include enhancing the frame portion of the input video stream to increase fidelity within the frame portion. The set of operations further include displaying the enhanced frame portion.

In some aspects of the present disclosure, a method for video stream refinement of a dynamic scene is provided. The method includes receiving an input video stream, identifying, within the input video stream, a subject of interest, and generating a subject frame around the subject of interest. The method further includes identifying, within the input video stream, a feature of interest that corresponds to the subject of interest, and generating a feature frame around the feature of interest. The method further includes enhancing the input video stream, within the feature frame, to increase fidelity within the feature frame, The method further includes enlarging the feature frame, and displaying the feature frame.

In some aspects of the present disclosure, a system is provided. The system includes at least one processor, and memory storing instructions that, when executed by the at least one processor, causes the system to perform a set of operations. The set of operations include receiving an input video stream, identifying, within the input video stream, a frame portion containing a subject of interest, and enhancing the frame portion of the input video stream. The set of operations further include displaying the enhanced frame portion moving across a display screen, the enhanced frame portion moving based on a movement of the subject of interest.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for video stream refinement according to aspects described herein.

FIG. 2 illustrates an overview of an example functional diagram of video stream refinement according to aspects described herein.

FIG. 3 illustrates an overview of an example method of video stream refinement according to aspects described herein.

FIG. 4 illustrates an overview of an example system for video stream refinement according to aspects described herein.

FIG. 5 illustrates an overview of an example method of video stream refinement according to aspects described herein.

FIG. 6 illustrates an overview of an example method of video stream refinement according to aspects described herein.

FIG. 7 illustrates an overview of an example system for video stream refinement according to aspects described herein.

FIG. 8 illustrates an overview of an example method of video stream refinement according to aspects described herein.

FIG. 9 is a block diagram illustrating example physical components of a computing device with which aspects of the disclosure may be practiced.

FIGS. 10A and 10B are simplified block diagrams of a mobile computing device with which aspects of the present disclosure may be practiced.

FIG. 11 is a simplified block diagram of a distributed computing system in which aspects of the present disclosure may be practiced.

FIG. 12 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user may run an application on a computing device that receives a video stream of the user in an environment. The user may be dynamic (e.g., moving) within the environment, thereby prompting the computing device to perform one or more actions on the video stream that it obtains. For example, the user may move away from a sensor (e.g., camera) that is generating the video stream. In response, the computing device may perform a digital zoom on the video stream to enlarge the user. Additionally, or alternatively, the user may move to a side of a sensor (e.g., camera) that is generating the video stream. In response, the computing device may perform a crop on the video stream to center the user in the video stream.

However, by performing a digital zoom on the video stream, the fidelity of the user may be lost (e.g., the user may appear in lower quality in the video stream after the digital zoom is performed, relative to the quality of the video stream before the digital zoom is performed). Performing an optical zoom to zoom in on the user would require expensive hardware that may not be commercially viable to include in, or with, the computing device. Further, enhancing the entire video stream can be a computationally expensive process. These and other difficulties may make video stream refinement for dynamic scenes frustrating to a user, and expensive to implement.

Accordingly, aspects of the present disclosure relate to video stream refinement for dynamic scenes that may be automatic and inexpensive to implement (in terms of necessary hardware, and computational costs). In examples, a computing device receives an input video stream. The video stream may contain a subject of interest (e.g., a user). A frame portion containing the subject of interest may be identified within the input video stream. The frame portion may be tracked throughout the video stream. The frame portion may be enlarged. Further, the frame portion may be enhanced, and the enhanced frame portion may be displayed.

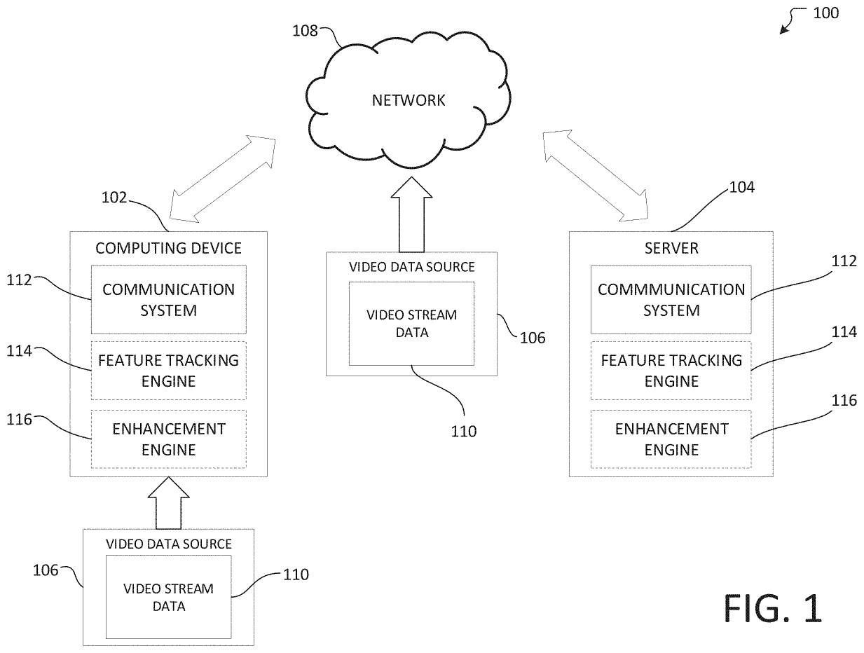

FIG. 1 shows an example of a system 100 for video stream refinement in accordance with some aspects of the disclosed subject matter. As shown in FIG. 1, the system 100 includes a computing device 102, a server 104, a video data source 106, and a communication network or network 108. The computing device 102 can receive video stream data 110 from the video data source 106, which may be, for example a webcam, video camera, video file, etc. Additionally, or alternatively, the network 108 can receive video stream data 110 from the video data source 106, which may be, for example a webcam, video camera, video file, etc.

Computing device 102 may include a communication system 112, a feature tracking engine 114, and an enhancement engine 116. In some examples, computing device 102 can execute at least a portion of feature tracking engine 114 to identify, locate, and/or track a subject of interest from the video stream data 110. Further, in some examples, computing device 102 can execute at least a portion of enhancement engine 116 to enhance (e.g., increase image fidelity) at least a portion of the video stream data 110. Increasing image fidelity from the video stream data 110 may include, for example, increasing the amount of bits per pixel in a portion of the video stream data 110, decreasing distortion within the video stream data 110 (e.g., using an image de-blurring, or similar algorithm), and/or reducing information loss within the video stream data 110 (e.g., by applying a trained model that is trained to reduce characteristic errors between an altered image and a ground truth image), etc.

Server 104 may include a communication system 112, a feature tracking engine 114, and an enhancement engine 116. In some examples, server 104 can execute at least a portion of feature tracking engine 114 to identify, locate, and/or track a subject of interest from the video stream data 110. Further, in some examples, server 104 can execute at least a portion of enhancement engine 116 to enhance (e.g., increase image fidelity) at least a portion of the video stream data 110.

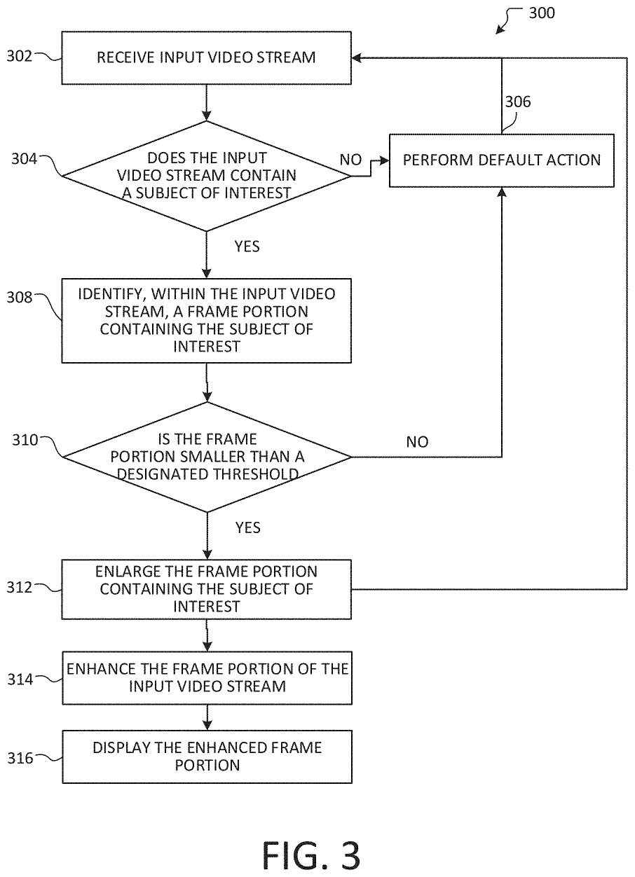

Additionally, or alternatively, in some examples, computing device 102 can communicate data received from video data source 106 to the server 104 over a communication network 108, which can execute at least a portion of feature tracking engine 114, and/or enhancement engine 116. In some examples, feature tracking engine 114 may execute one or more portions of methods/processes 300, 500, and/or 700 described below in connection with FIGS. 3, 5, and 7. Further, in some examples, enhancement engine 116 may execute one or more portions of methods/processes 300, 500, and/or 700 described below in connection with FIGS. 3, 5, and 7.

In some examples, computing device 102 and/or server 104 can be any suitable computing device or combination of devices, such as a desktop computer, a laptop computer, a smartphone, a tablet computer, a wearable computer, a server computer, a virtual machine being executed by a physical computing device, etc.

In some examples, video data source 106 can be any suitable source of video stream data (e.g., data generated from a computing device, data generated from a webcam, data generated from a video camera, etc.) In a more particular example, video data source 106 can include memory storing video stream data (e.g., local memory of computing device 102, local memory of server 104, cloud storage, portable memory connected to computing device 102, portable memory connected to server 104, etc.). In another more particular example, video data source 106 can include an application configured to generate video stream data (e.g., a teleconferencing application with video streaming capabilities, a feature tracking application, and/or a video enhancement application being executed by computing device 102, server 104, and/or any other suitable computing device).

In some examples, video data source 106 can be local to computing device 102. For example, video data source 106 can be a camera that is coupled to computing device 102. Additionally, or alternatively, video data source 106 can be remote from computing device 102, and can communicate video stream data 110 to computing device 102 (and/or server 104) via a communication network (e.g., communication network 108).

In some examples, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 108 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

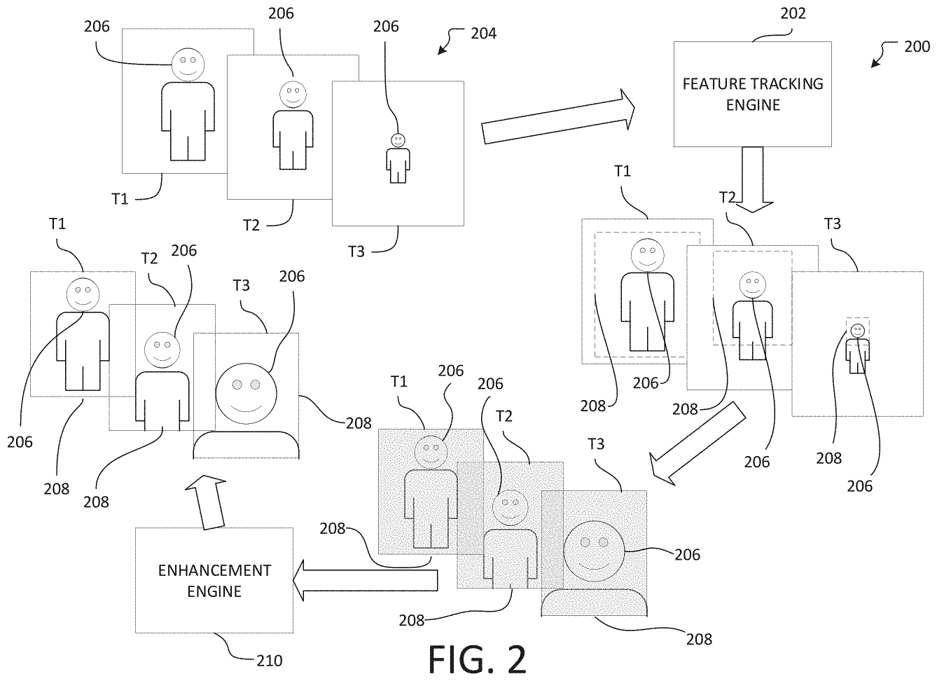

FIG. 2 illustrates an overview of an example 200 functional diagram of video stream refinement according to aspects described herein. A feature tracking engine 202 may receive an input video stream 204 (e.g., the video stream data 110 from video data source 106 of FIG. 1). The feature tracking engine 202 may be similar to the feature tracking engine 114, discussed above with respect to FIG. 1. The input video stream 204 may be a batch (e.g., collection) of still images taken at sequential time intervals. Alternatively, the input video stream 204 may be single instances of still images taken at moments of time. For example, the input video stream of FIG. 2 includes a batch of three still images taken at a first time T1, a second time T2, and a third time T3. It should be understood that times T1, T2, and T3 may be any moments in time with a specified regular durations of time therebetween, or alternatively, any moments in time with specified irregular durations of time therebetween. The times T1, T2, and T3 may be designated by a user. Additionally, or alternatively, the times T1, T2, and T3 may be automatically generated (e.g., based on developer settings, or preferences).

In some examples, the input video stream 204 may include 3-dimensional (3D) scenes. Accordingly, aspects of the present disclosure described below (e.g., enlarging, enhancing, tracking, etc.) can be applied to the 3-dimensional scenes in a similar manner as they would be applied to a 2-dimensional scene. For example, systems described herein can identify a 3D sub-scene of the input video stream 204 (e.g., containing a person, or object, or animal of interest), enlarge the 3D sub-scene, and enhance the 3D sub-scene to improve fidelity of the 3D sub-scene (e.g., after fidelity of the 3D sub-scene has been lost, due to being enlarged).

After feature tracking engine 202 receives the input video stream 204, the feature tracking engine 202 may identify, within the input video stream 204, one or more subjects of interest 206 (e.g., humans, animals, objects). The one or more subjects of interest 206 may be tracked (e.g., their location monitored and followed) using mechanisms described herein. Further, the feature tracking engine 202 may identify specific features from the subjects of interest 206. Specifically, the feature tracking engine 202 may identify one or more frame portions 208 within the input video stream 204. For example, the feature tracking engine may identify a frame portion containing facial features (e.g., eyes, mouth, nose, hair, and/or ears), body features (e.g., head, arms, legs, and/or torso), or other specific features that are desirable for a user to identify and/or track. In some examples, the feature tracking engine can also detect features (e.g., face, mouth, hands, etc.) to determine localized enhancement regions that systems disclosed herein are configured to increase image fidelity thereof.

Referring specifically to FIG. 2, the feature tracking engine 202 identifies, within the input video stream 204, one or more frame portions 208. The feature tracking engine 202 identifies, within the input video stream 204, a frame portion 208 containing a user's body at time T1. Further, the feature tracking engine 202 identifies, within the input video stream 204, a frame portion 208 containing a user's head, arms, and torso at time T2. Still further, the feature tracking engine 202 identifies, within the input video stream 204, a frame portion 208 containing a user's head at time T3. The one or more frame portions 208 from the input video stream 204 may then be enlarged. However, as mentioned earlier herein, enlarging the frame portions 208 may cause the fidelity of features within the frame portions 208 to be reduced.

Accordingly, an enhancement engine 210 may receive the one or more of the frame portions 208, after the frame portions 208 have been enlarged. The enhancement engine 210 may be similar to the enhancement engine 116 discussed above with respect to FIG. 1. The enhancement engine 210 may enhance the frame portions 208 of the input video stream 204 that have been enlarged, thereby creating enhanced frame portions. For example, the enhancement engine 210 may increase the fidelity of the frame portions 208, after they have been enlarged, relative to the frame portions 208, before they were enlarged. The enhancement engine 210 may output the frame portions 208 that have been enhanced. The enhanced frame portions 208 may then be displayed (e.g., via a display of computing device 102).

FIG. 3 illustrates an overview of an example method 300 of video stream refinement according to aspects described herein. In examples, aspects of method 300 are performed by a device, such as computing device 102, or server 104 discussed above with respect to FIG. 1.

Method 300 begins at operation 302, wherein an input video stream is received. For example, the input video stream may be received via a video data source (e.g., video data source 106 discussed above with respect to FIG. 1). As mentioned above, the video data source may be, for example a webcam, video camera, video file, etc. In some examples, the operation 302 may comprise obtaining the input video stream. For example, the input video stream may be obtained by executing commands, via a processor, that cause the input video stream to be received by, for example, a feature tracking engine, such as feature tracking engine 202.

At determination 304, it is determined whether the input video stream contains a subject of interest (e.g., a user). The one or more users may be identified by one or more computing devices (e.g., computing device 102, and/or server 104). Specifically, the one or more computing devices may receive visual data from a visual data source (e.g., video data source 106) to identify one or more subjects of interest. The visual data may be processed, using mechanisms described herein, to recognize that one or more persons, one or more animals, and/or one or more objects of interest are present. The one or more persons, one or more animals, and/or one or more objects may be recognized based on a presence of the persons, animals, and/or objects, motions of the persons, animals, and/or objects, and/or other scene properties of the input video stream, such as differences in color, contrast, lighting, spacing between subjects, etc.

Additionally, or alternatively, 304, the one or more subjects of interest (e.g., a user) may be identified by engaging with a specific software (e.g., joining a call, joining a video call, joining a chat, or the like). A user may be identified by logging into a specific application (e.g., via a passcode, biometric entry, or registration number). Therefore, when the specific application is logged into, the user is thereby identified. For example, when a user joins a video call, it may be determined that the input video stream contains a subject of interest (i.e., the user). Additionally, or alternatively, at determination 304, it may be determined that the input video stream contains a subject of interest by identifying the subject of interest using a radio frequency identification tag (RFID), an ID badge, a bar code, or some other means of identification that is capable of identifying a subject of interest via some technological interface.

At determination 304, it may further be determined whether the subject of interest contains a feature of interest (e.g., a face of a user). Such determinations may be made using visual processing algorithms, such as machine learning algorithms, that are trained to recognize subjects of interest described herein. For example, the input video stream may be comprised of one or more frames. A mesh may be generated over a portion of one or more of the one or more frames. The mesh may be used to identify whether the subject of interest contains a feature of interest.

It will be appreciated that method 300 is provided as an example where a subject of interest is or is not identified at determination 304. In other examples, it may be determined to request clarification or disambiguation from a user (e.g., prior to proceeding to either operation 306 or 308), as may be the case when a confidence level associated with identifying a subject of interest is below a predetermined threshold or when multiple subjects of interests are identified, among other examples. In examples where such clarifying user input is received, an indication of the subject of interest may be stored (e.g., in association with the received input video stream) and used to improve accuracy when processing similar future video stream input.

If it is determined that there is not a subject of interest contained within the input video stream, flow branches “NO” to operation 306, where a default action is performed. For example, the input video stream may have an associated pre-configured action (such as not presenting the input video stream). In other examples, method 300 may comprise determining whether the input video stream has an associated default action, such that, in some instances, no action may be performed as a result of the received input video stream (e.g., the input video stream may be displayed using conventional methods). Method 300 may terminate at operation 306. Alternatively, method 300 may return to operation 302 to provide a continuous video stream feedback loop.

If however, it is determined that the input video stream contains a subject of interest, flow instead branches “YES” to operation 308, where a frame portion containing the subject of interest is identified. For example, if the subject of interest is a human, then the frame portion may be a rectangular, or other polygonal shape around the human in the input video stream. In examples, the frame portion may be tracked over a time interval, such that movements of the subject of interest can be tracked throughout the input video stream.

It will further be appreciated that method 300 is provided as an example where the frame portion is or is not smaller than a designated threshold at determination 310. The designated threshold may be a ratio of an area of the frame portion to an area of a display screen (e.g., a display screen of computing device 102) that the frame portion may be displayed thereon. In this regard, if the designated threshold is 1, then determination 310 will determine if an area of the frame portion is smaller than (e.g., less than) an area of a display screen that the frame portion is displayed thereon. Alternatively, if the designated threshold is 0.5, then determination 310 will determine if an area of the frame portion is less than half of an area of a display screen that the frame portion is displayed thereon. Generally, determination 310 determines the size of the frame portion relative to the size of a display screen that the frame portion may be displayed thereon.

If it is determined that the frame portion is not smaller than the designated threshold, flow branches “NO” to operation 306, where a default action is performed. For example, the frame portion may have an associated pre-configured action (such as not presenting the input video stream). In other examples, method 300 may comprise determining whether the input video stream has an associated default action, such that, in some instances, no action may be performed as a result of the received input video stream (e.g., the input video stream may be displayed using conventional methods). Method 300 may terminate at operation 306. Alternatively, method 300 may return to operation 302 to provide a continuous video stream feedback loop.

If however, it is determined that the input video stream contains a subject of interest, flow instead branches “YES” to operation 312, wherein the frame portion containing the subject of interest is enlarged. The enlargement process may be a digital zoom that enlarges that subject of interest on a display screen. Additionally, or alternatively, the enlargement process may be a digital zoom that enlarges pixels corresponding to the frame portion, and stores the enlarged pixels in memory (e.g., memory of computing device 102, or server 104). The enlarged pixels may then be retrieved (e.g., from memory of computing device 102, or server 104) to be displayed.

Flow progresses to operation 314, where the frame portion of the input video stream (e.g., the same frame portion that was enlarged) is enhanced. Generally, when digital zoom is performed on a subject of interest, the subject may lose fidelity (e.g., become blurrier, or lose image quality) relative the subject of interest, before the digital zoom was performed. Therefore, some examples of the present disclosure may include training a model (e.g., a machine learning model, statistical model, linear algorithm, or non-linear algorithm) to reduce a loss of fidelity in the subject of interest when the frame portion containing the subject of interest is enlarged.

Still referring to FIG. 3, flow progresses to operation 316, where the enhanced frame portion is displayed. For example, the input video stream may be displayed on a screen of a computing device (e.g., computing device 102). The input video stream may be replaced by the enhanced frame portion. Method 300 may terminate at operation 306. Alternatively, method 300 may return to operation 302 to provide a continuous video stream feedback loop. For example, the method 300 may constantly be receiving input video streams, identifying, within the input video stream, a frame portion containing a subject of interest, enlarging the frame portion containing the subject of interest, enhancing the frame portion of the input video stream, and updating the display screen by displaying the enhanced frame portion. The method 300 may be run at a continuous interval. Alternatively, the method 300 may iterate through at specified intervals. Alternatively, the method 300 may be triggered to execute by a specific action, for example by a computing device receiving an input video stream.

Generally, method 300 provides an example where video stream enhancement is performed by identifying a frame portion containing a subject of interest, enlarging the frame portion, and enhancing the frame portion. Such a method allows for increased video quality on aspects of an input video stream that are of interest to a user, without excessive computational costs.

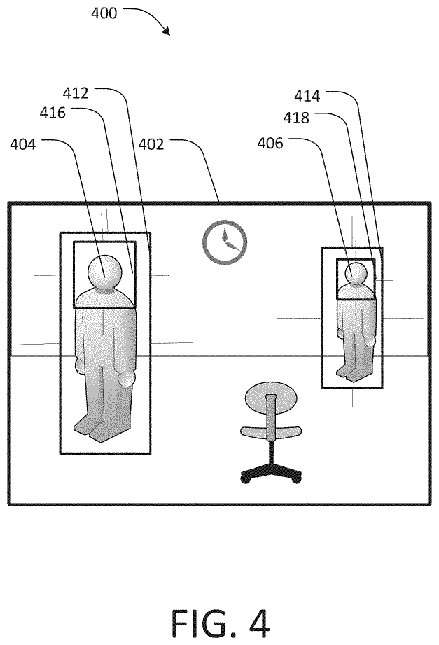

FIG. 4 illustrates an overview of an example system 400 for video stream refinement according to aspects described herein. Generally, the system 400 includes a display screen 402 (e.g., a display screen of computing device 102) showing one or more subjects of interest, for example a first subject of interest or person or user 404, and a second subject of interest or person or user 406.

Generally, mechanisms disclosed herein (e.g., the feature tracking engine 114) generate a body frame (e.g., a rectangle or other polygonal shape) around one or more subjects of interest. Further, mechanisms disclosed herein may generate a feature frame (e.g., a rectangle or other polygonal shape) around one or more features of the one or more subjects of interest. For example, FIG. 4 illustrates that the display screen 402 displays a first body frame 412 around the first user 404, and a second body frame 414 around the second user 406. Further, the display screen 402 displays a first feature frame 416 around the head of the first user 404, and a second feature frame 418 around the head of the second user 406.

While the frames 412, 414, 416, and 418 are shown to be visible on the display screen 402, it is contemplated that, in some examples, the frame 412, 414, 416, and 418 may not be visible. Rather, a location of the frames 412, 414, 416, and 418 may be stored in memory, for further processing, without a graphic of the frames 412, 414, 416 and 418 actually being displayed (e.g., on a display screen, such as display screen 402). The location of the frames 412, 414, 416, and 418 may be useful to provide a buffer along which an enhancement engine (e.g., enhancement engine 116) may blend enhancements of any video stream portions into video stream portions that are unenhanced (e.g., not enhanced).

Generally, subjects of interest (e.g., first user 404 and/or second user 406) may be tracked throughout an input video stream. As such, if the first user 404 were to move to the second user 406, then the display screen 402 may be updated to show the first user 404 located at the second user's 406 position. Further, system 400 may generate updated frames (e.g., first body frame 412, second body frame 414, first feature frame 416, and/or second feature frame 418). The frames may move along the display screen 402 in the same manner as the users 404, 406. Accordingly the frame's location with respect to the display screen 402 may correspond to the user's 404, 406 location with respect to the display screen 402.

Additionally, or alternatively, tracking a subject of interest (e.g., first user 404 and/or second user 406) may comprise sending commands to a video data source (e.g., a camera) to pan, tilt, or zoom in order to track the subject of interest. In some examples, panning, tilting, and/or zooming can be optical functions that are prompted by mechanisms described herein. Alternatively, in some examples, a computer generated display (e.g., shown on display screen 402) may be updated to digitally pan towards, tilt toward, or zoom into one or more subjects of interest.

In some examples, there may be a plurality of subjects of interest (e.g., users 404, 406). Alternatively, there may be only one subject of interest (e.g., one of user 404 or 406). When there are a plurality of subjects of interest (e.g., users 404, 406), mechanisms described herein may prioritize one of the subjects of interest to be tracked, and/or enhanced. When there are a plurality of subjects of interest, mechanisms described herein may identify a focal subject of interest (e.g., one of users 404 or 406). The focal subject of interest in a video data stream may be one from the plurality of subjects of interest who is closest to the sensor (e.g., camera) from which the video data stream was collected. Alternatively, the focal subject of interest may be furthest from the sensor (e.g., camera) from which the video data stream was collected. Alternatively, the focal subject of interest may be the most centrally located subject of interest on a display screen (e.g., display screen 402).

In some examples, a focal subject of interest may be predetermined based on training data. For example, aspects of the present disclosure can be trained to recognize facial characteristic of a specific user. If the specific user is recognized amongst a plurality of subjects of interest, then the specific user may be the focal subject of interest. Additionally, or alternatively, a focal subject of interest may be identified via a radio frequency identification tag (RFID), an ID badge, a bar code, a fiducial marker or some other means of identification that is capable of identifying a focal subject of interest via a technological interface.

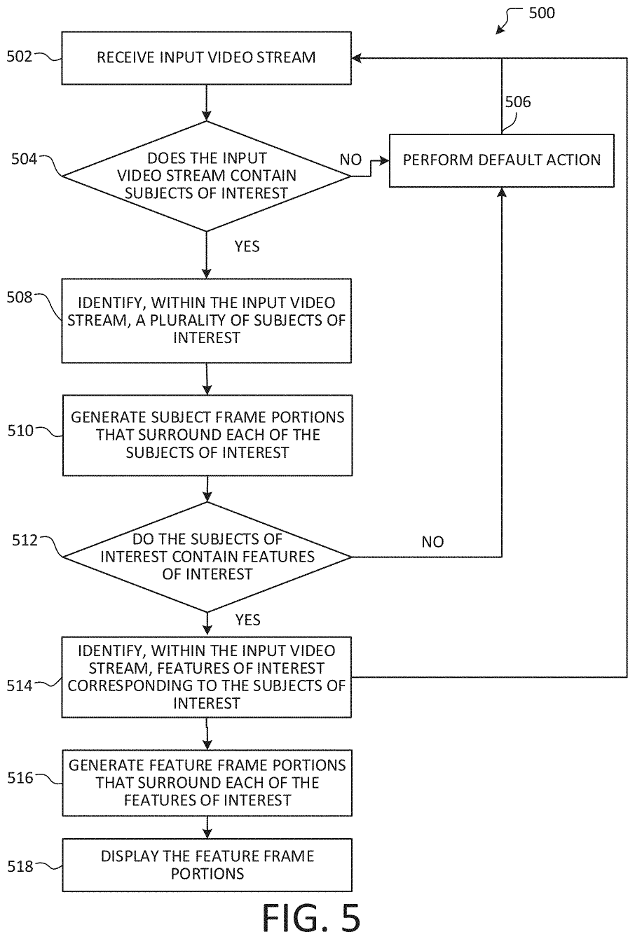

FIG. 5 illustrates an overview of an example method 500 of video stream refinement according to aspects described herein. In examples, aspects of method 500 are performed by a device, such as computing device 102, or server 104 discussed above with respect to FIG. 1.

Method 500 begins at operation 502, wherein an input video stream is received. For example, the input video stream may be received via a video data source (e.g., video data source 106 discussed above with respect to FIG. 1). As mentioned above, the video data source may be, for example a webcam, video camera, video file, etc. In some examples, the operation 502 may comprise obtaining the input video stream. For example, the input video stream may be obtained by executing commands, via a processor, that cause the input video stream to be received by, for example, a feature tracking engine, such as feature tracking engine 202.

At determination 504, it is determined whether the input video stream contains subjects of interest (e.g., a plurality of users). The plurality of users may be identified by one or more devices (e.g., computing device 102, and/or server 104). Specifically, the one or more devices may receive visual data from a visual data source (e.g., video data source 106) to identify a plurality of subjects of interest. The visual data may be processed, using mechanisms described herein, to recognize that one or more persons, one or more animals, and/or one or more objects of interest are present. The one or more persons, one or more animals, and/or one or more objects may be recognized based on a presence of the persons, animals, and/or objects, motions of the persons, animals, and/or objects, and/or other scene properties of the input video stream, such as differences in color, contrast, lighting, spacing between subjects, etc.

Additionally, or alternatively, 504, the subjects of interest (e.g., a plurality of users) may be identified by engaging with a specific software (e.g., joining a call, joining a video call, joining a chat, or the like). The users may be identified by logging into a specific application (e.g., via a passcode, biometric entry, or registration number). Therefore, when the specific application is logged into, the users are thereby identified. For example, when a user joins a video call, it may be determined that the input video stream contains a subject of interest (i.e., the user). Additionally, or alternatively, at determination 304, it may be determined that the input video stream contains a subject of interest by identifying the subject of interest using a radio frequency identification tag (RFID), an ID badge, a bar code, or some other means of identification that is capable of identifying a subject of interest via some technological interface.

It will be appreciated that method 500 is provided as an example where subjects of interest are or are not identified at determination 504. In other examples, it may be determined to request clarification or disambiguation from a user (e.g., prior to proceeding to either operation 506 or 508), as may be the case when a confidence level associated with identifying subjects of interest is below a predetermined threshold, among other examples. In examples where such clarifying user input is received, an indication of the subjects of interest may be stored (e.g., in association with the received input video stream) and used to improve accuracy when processing similar future video stream input.

If it is determined that there are not subjects of interest contained within the input video stream, flow branches “NO” to operation 506, where a default action is performed. For example, the input video stream may have an associated pre-configured action (such as not presenting the input video stream). In other examples, method 500 may comprise determining whether the input video stream has an associated default action, such that, in some instances, no action may be performed as a result of the received input video stream (e.g., the input video stream may be displayed using conventional methods). Method 500 may terminate at operation 506. Alternatively, method 500 may return to operation 502 to provide a continuous loop of receiving an input video stream and determining whether the input video stream contains subjects of interest.

If however, it is determined that the input video stream contains subjects of interest, flow instead branches “YES” to operation 508, where, within the input video stream, a plurality of subjects of interest are identified.

At operation 510, subject frame portions that surround of the subjects of interest are generated. For example, referring to FIG. 4, system 400 may identify the first subject of interest 404, and the second subject of interest 406. Then, subject frame portions (e.g., first and second body frames 412, 414) may be generated to visually monitor and track the plurality of users. In some examples, operation 510 includes inputting, or receiving preferences (e.g., settings 410) to adjust the width, height, and/or tolerance (e.g., range) of the subject frame portions.

At determination 512, it is determined whether the subjects of interest contain features of interest (e.g., facial characteristics, and/or body parts). The features of interest may be identified by one or more computing devices (e.g., computing device 102, and/or server 104). Specifically, the one or more computing devices may receive visual data from a visual data source (e.g., video data source 106) to identify features of interest on the already identified subjects of interest. The visual data may be processed, using mechanisms described herein, to perform facial recognition on the one or more users. For example, the one or more computing devices may create a mesh over portions of the subjects of interest to identify features of interest.

It will be appreciated that method 500 is provided as an example where the subjects of interest do and do not contain features of interest. In other examples, it may be determined to request clarification or disambiguation from a user (e.g., prior to proceeding to either operation 306 or 308), as may be the case when a confidence level associated with identifying features of interest is below a predetermined threshold, among other examples. In examples where such clarifying user input is received, an indication of the features of interest may be stored (e.g., in association with the received input video stream) and used to improve accuracy when processing similar future video stream input.

If it is determined that there are no features of interest contained within the input video stream, flow branches “NO” to operation 506, where a default action is performed. For example, if the subjects of interest are person, and the features of interest are faces, but the persons' faces are not shown in the input video stream, then no features of interest may be identified. In such cases, the input video stream may have an associated pre-configured action (such as not presenting the input video stream). In other examples, method 500 may comprise determining whether the input video stream has an associated default action, such that, in some instances, the input video stream may be displayed showing the subject frame portions generated by operation 510. Method 500 may terminate at operation 506. Alternatively, method 500 may return to operation 502 to provide a continuous video stream feedback loop.

If however, it is determined that the subjects of interest contain features of interest, flow instead branches “YES” to operation 514, where, within the input video stream, features of interest corresponding to the subjects of interest are identified. In some examples, operation 514 may include identifying bodies of people, or heads of people, or faces of people, or hands of people, or bodies of animals, or faces of animals, or hands of animals, etc.

At operation 516, frame portions are generated that surround each of the features of interest that were identified in operation 514. For example, referring to FIG. 4, when the features of interest are heads, system 400 generates the first feature frame 416 and the second feature frame 418 around the heads of the first subject of interest 404 and the second subject of interest 406, respectively. It should be noted that similar functionality may be executed with respect to other features of interest that are of desired to be tracked or observed with respect to subjects of interest described herein.

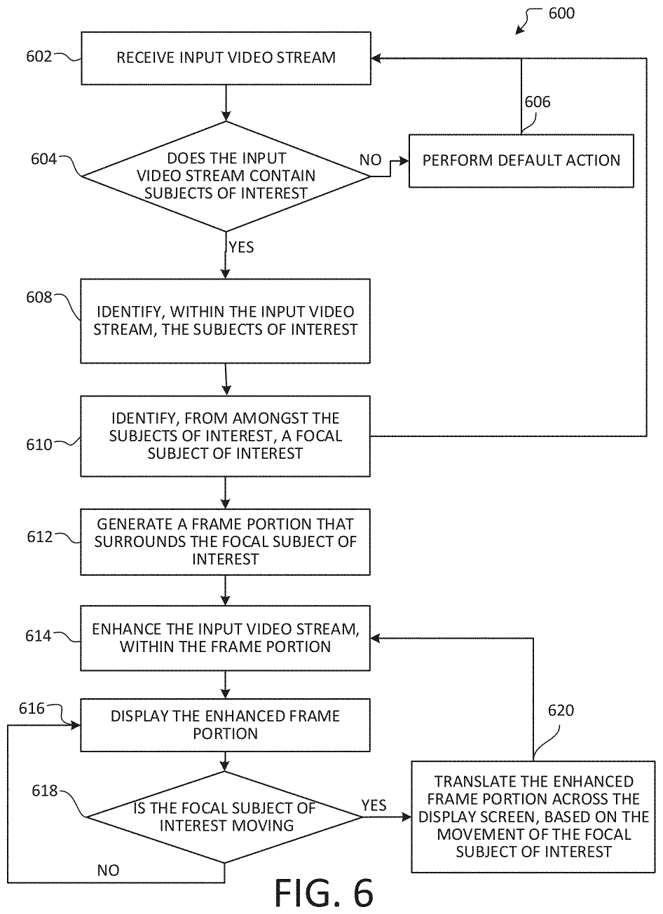

FIG. 6 illustrates an overview of an example method 600 of video stream refinement according to aspects described herein. In examples, aspects of method 600 are performed by a device, such as computing device 102, or server 104 discussed above with respect to FIG. 1.

Method 600 may be similar to method 500 in some aspects. For example, at operation 602, an input video stream is received, at operation 604, it is determined if the input video stream contains a subject of interest, at operation 606, a default action may be performed, and at operation 608, the subjects of interest are identified within the input video stream. However, in some aspects, method 600 differs from method 500.

At operation 610, a focal subject of interest is identified from amongst the subjects of interest. In some examples, multiple individuals, animals, or objects of interest may be shown via an input video stream. However, it may only be desired, or possible, to track one of the subjects of interest (e.g., individuals, animals, or objects). Accordingly, it may be necessary to determine which subject of interest is desired to be focused on for further processing.

The focal subject of interest in a video data stream may be one from the plurality of subjects of interest that is closest to the sensor (e.g., camera) from which the video data stream was collected. Alternatively, the focal subject of interest may be furthest from the sensor (e.g., camera) from which the video data stream was collected. Alternatively, the focal subject of interest may be the most centrally located subject of interest on a display screen (e.g., display screen 402).

In some examples, a focal subject of interest may be predetermined based on training data. For example, aspects of the present disclosure can be trained to recognize facial characteristic, and/or body characteristics of a specific user. If the specific user is recognized amongst a plurality of subjects of interest, then the specific user may be identified as the focal subject of interest. Additionally, or alternatively, a focal subject of interest may be identified via a radio frequency identification tag (RFID), an ID badge, a bar code, a fiducial marker or some other means of identification that is capable of identifying a focal subject of interest via a technological interface.

At operation 612, a frame portion is generated that surrounds the focal subject of interest. A frame portion may be generated around only the focal subject of interest, so as to prevent any unnecessary processing to track, and/or enhance, subjects of interest that are not designated to be the focal subject of interest. Accordingly, aspects of the present disclosure may provide method for video enhancing that are relatively computationally inexpensive. The frame portion generated at operation 612 may surround an entire focal subject of interest. Alternatively, a feature of interest (e.g., as discussed with respect to method 500) may be identified on the focal subject of interest, and the frame portion may be generated around the feature of interest located on the focal subject of interest.

In some examples, after operation 612, the frame portion that contains the focal subject of interest may be enlarged. The frame portion may be enlarged in a similar manner as discussed earlier herein with respect to operation 312 of method 300. For example, the input video stream may be cropped from its original size, and the frame portion may be enlarged to the original size of the input video stream (e.g., fully up-scaled) to focus on the focal subject of interest.

At operation 614, the input video stream may be enhanced within the frame portion. Therefore, the focal subject of interest may be enhanced to improve viewing quality on a display screen (e.g., display screen 402, and/or a display screen of computing device 102).

Flow progresses to operation 616, where the enhanced frame portion is displayed. For example, the input video stream may be displayed on a screen of a computing device (e.g., computing device 102).

At operation 618, it is determined whether the focal subject of interest is moving (e.g., within the input video steam). If the focal subject of interest is not moving, flow branches “NO” and return to operation 616, wherein the enhanced frame portion of operation 614 continues to be displayed. Alternatively, if the focal subject of interest is moving, flow branches “YES” to operation 620. At operation 620, the enhanced frame portion is translated (e.g., moved) across the display screen, based on the movement of the focal subject of interest. In this respect, method 600 may track the focal subject of interest as they move (e.g., side-to-side, diagonal, forward, backward, up, down) within the input video stream.

From operation 618, flow may progress to operation 614, wherein the input video stream is enhanced within the frame portion, after the location of the frame portion is updated, based on the movement of the focal subject of interest. Flow then progresses to operation 616, wherein the display is updated with the re-enhanced frame portion. Generally, operations 614-620 of method 600 provide the ability to track a subject of interest, and to continuously re-enhance, and re-display the subject of interest, despite their location within an input video stream. For example, if the subject of interest is a person, and the person moves away from a camera that outputs the input video stream, then the person may appear smaller in the input video stream. Accordingly, mechanisms disclosed herein may magnify the person, and the person will be re-enhanced, such that fidelity is not lost for display.

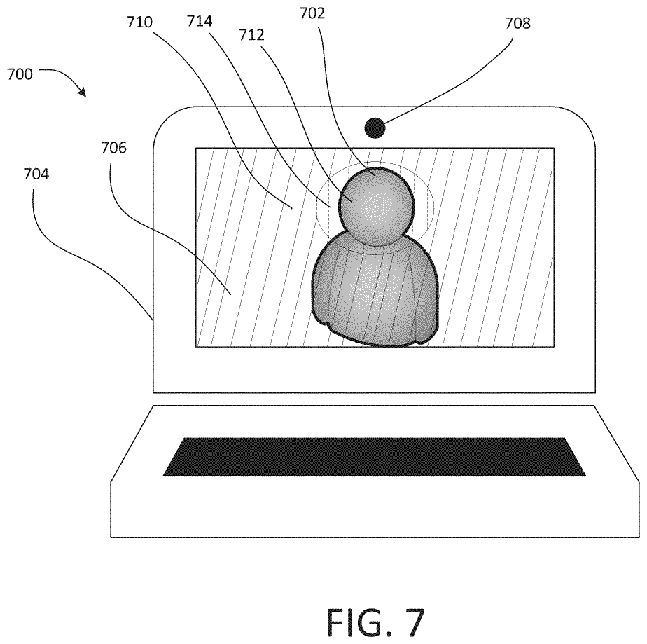

FIG. 7 illustrates an overview of an example system 700 for video stream refinement according to aspects described herein. System 700 includes a user 702, and a computing device 704. The computing device 704 may be similar to the computing device 104 discussed with respect to FIG. 1. The computing device 704 includes a display screen 706, and a sensor 708. The sensor 708 is a camera. The sensor 708 may receive visual data, and the visual data may be converted into a video stream that is displayed on the display screen 706 of the computing device 704.

Generally, system 700 illustrates video stream enhancement of a user, wherein a portion of the video stream is enhanced, a portion of the video stream is unenhanced, and a portion of the video stream is partially-enhanced to transition from the enhanced portion to the unenhanced portion. Specifically, FIG. 7 illustrates an unenhanced (e.g., not enhanced) portion 710 of a video stream. The unenhanced portion 710 may be blurry due to a digital zoom that enlarged the video stream. Additionally, or alternatively, the unenhanced portion may be blurred (e.g., via conventional blurring methods) to highlight aspects of the video stream that are of interest to a user (e.g., the user's face).

FIG. 7 further illustrates an enhanced portion 712 of the video stream. The enhanced portion is configured to improve fidelity of a user after execution of pan, tilt, or zoom functions that may otherwise decrease the fidelity of a user being displayed (e.g., user 702). The enhanced portion 712 may be enhanced by a trained model (e.g., a machine learning model, linear algorithm, non-linear algorithm, etc.). The trained model may be trained based on a loss of fidelity between one or more original (e.g., unenhanced) images and one or more enhanced images, wherein the one or more enhanced images correspond to the one or more original images. The model may be trained by up-sampling an original (e.g., unenhanced) image using an up-sampler, determining a loss in fidelity between the original image and the up-sampled image, and modifying the up-sampled image to reduce the loss in fidelity.

Between the enhanced portion 712 of the video stream and the unenhanced portion 710 of the video stream, a partially-enhanced or transition portion 714 may be displayed. The transition portion 714 may blend the enhanced portion 712 into the unenhanced portion 710 to create a visually appealing transition therebetween. In some examples, the transition portion 714 may be omitted, and the enhanced portion 712 may transition directly into the not-enhanced portion 714.

The transition portion 714 may be the result of a portion of the video stream being partially-enhanced. The transition portion 714 may be partially-enhanced by the trained model that is used to generate the enhanced portion 712. Alternatively, the transition portion 714 may be partially-enhanced by a separate trained model that is trained to have a fiducial loss that is higher than that of the trained model that is used to generate the enhanced portion 712.

The size of the enhanced portion 712 can be automatically determined by mechanisms disclosed herein. For example, a perimeter of the enhanced portion 712 may overlay a perimeter of a subject of interest, or of a feature of interest (e.g., the user 702, or a head of the user 702). Alternatively, the perimeter of the enhanced portion 712 may be offset from a perimeter of the subject of interest, or of the feature of interest, by a predetermined amount of pixels.

Similarly, the size of the transition portion 714 can be automatically determined by mechanisms disclosed herein. Alternatively, the size of the transition portion 714 may be pre-determined by a user or developer. For example, a perimeter of the transition portion 714 can be offset from a perimeter of the enhanced portion 712 by a predetermined amount. Increasing the sizes of the transition portion 714 allows for a smoother blend from the enhanced portion 712 to the unenhanced portion 710. However, decreasing the size of the transition portion 714 allows for decreased computational costs in generating the display screen 706.

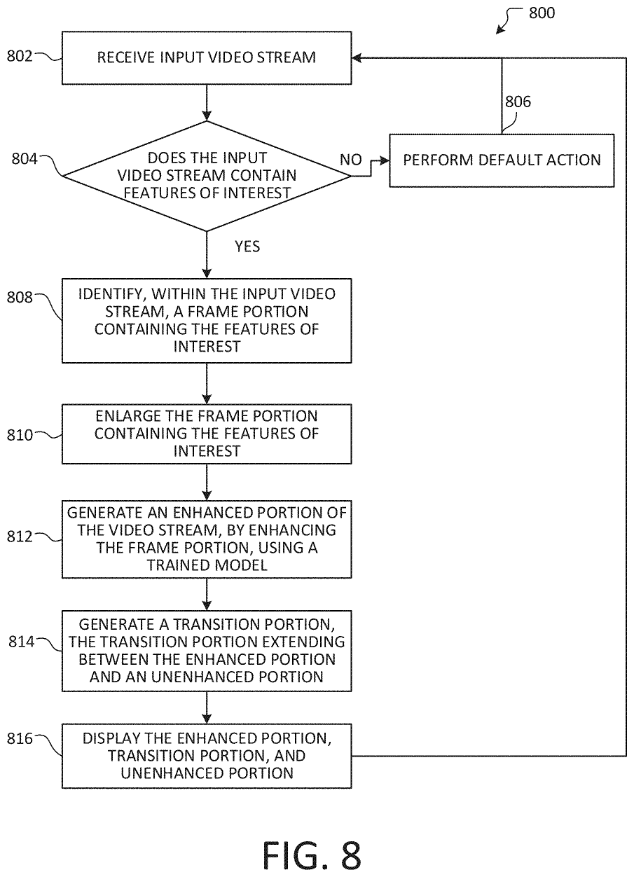

FIG. 8 illustrates an overview of an example method 800 of video stream refinement according to aspects described herein. In examples, aspects of method 800 are performed by a device, such as computing device 102, or server 104 discussed above with respect to FIG. 1.

Method 800 begins at operation 802, wherein an input video stream is received. For example, the input video stream may be received via a video data source (e.g., video data source 106 discussed above with respect to FIG. 1). As mentioned above, the video data source may be, for example a webcam, video camera, video file, etc. In some examples, the operation 802 may comprise obtaining the input video stream. For example, the input video stream may be obtained by executing commands, via a processor, that cause the input video stream to be received by, for example, a feature tracking engine, such as feature tracking engine 202.

At determination 804, it is determined whether the input video stream contains features of (e.g., a head of user 702). The features of interest may be identified by one or more computing devices (e.g., computing device 102, and/or server 104). Specifically, the one or more computing devices may receive visual data from a visual data source (e.g., video data source 106) to identify the features of interest. The visual data may be processed, using mechanisms described herein, to perform image recognition on the one or more users. For example, the one or more computing devices may create a mesh over the visual data and analyze pixels within the mesh to determine whether feature of interest are contained within the input video stream.

It will be appreciated that method 800 is provided as an example where features of interest are or are not identified at determination 804. In other examples, it may be determined to request clarification or disambiguation from a user (e.g., prior to proceeding to either operation 806 or 808), as may be the case when a confidence level associated with identifying features of interest are below a predetermined threshold, among other examples. In examples where such clarifying user input is received, an indication of the features of interest may be stored (e.g., in association with the received input video stream) and used to improve accuracy when processing similar future video stream input.

If it is determined that there are not features of interest contained within the input video stream, flow branches “NO” to operation 806, where a default action is performed. For example, the input video stream may have an associated pre-configured action (such as not presenting the input video stream). In other examples, method 800 may comprise determining whether the input video stream has an associated default action, such that, in some instances, no action may be performed as a result of the received input video stream (e.g., the input video stream may be displayed using conventional methods). Method 800 may terminate at operation 806. Alternatively, method 800 may return to operation 802 to provide a continuous video stream feedback loop.

If however, it is determined that the input video stream contains a subject of interest, flow instead branches “YES” to operation 808, where a frame portion containing the features of interest is identified. For example, if the features of interest are the facial characteristics of a user, then the frame portion may be a rectangular, circular, elliptical, or other polygonal shape around the face of the user in the input video stream. In examples, the frame portion may be tracked over a time interval, such that movements of the subject of interest can be tracked, and stored (e.g., in memory), throughout the input video stream.

Flow progresses to operation 810, where the frame portion containing the features of interest is enlarged. The enlargement process may be a digital zoom that enlarges the features of interest on a display screen. Additionally, or alternatively, the enlargement process may be a digital zoom that enlarges pixels corresponding to the frame portion, and stores the enlarged pixels in memory (e.g., memory of computing device 102, or server 104). The enlarged pixels may then be retrieved (e.g., from memory of computing device 102, or server 104) to be displayed.

Flow progresses to operation 812, where an enhanced portion of the input video stream is generated, by enhancing the frame portion of operation 810, using a trained model. The enhanced portion is configured to improve fidelity of a user after execution of pan, tilt, or zoom functions that may otherwise decrease the fidelity of a user being displayed (e.g., user 702). The enhanced portion (e.g., enhanced portion 712) may be enhanced by a trained model (e.g., a machine learning model, linear algorithm, and/or non-linear algorithm). The trained model may be trained based on a loss of fidelity between one or more original (e.g., unenhanced) images and one or more enhanced images, wherein the one or more enhanced images correspond to the one or more original images. The model may be trained by up-sampling an original (e.g., unenhanced) image using an up-sampler, determining a loss in fidelity between the original image and the up-sampled image, and modifying the up-sampled image to reduce the loss in fidelity.

Flow progresses to operation 814, where a transition portion is generated. The transition portion may extend between the enhanced portion and an unenhanced portion of the video stream. For example, FIG. 7 displays a transition portion 714 that extends between enhanced portion 712 and unenhanced portion 710 in system 700. The transition portion may be generated by being partially-enhanced. The transition portion may be partially-enhanced by the trained model that is used to generate the enhanced portion in operation 812. Alternatively, the transition portion may be partially-enhanced by a separate trained model that is trained to have a fiducial loss that is higher (e.g., producing lower quality images) than that of the trained model that is used to generate the enhanced portion of operation 812.

Flow advances to operation 816, where the enhanced portion, transition portion, and unenhanced portion of the video stream are displayed. For example, the input video stream may be displayed on a screen of a computing device (e.g., computing device 102). The input video stream may be replaced by the enhanced frame portion, transition portion, and unenhanced portion. Method 800 may terminate at operation 816. Alternatively, method 800 may return to operation 802 to provide a continuous video stream feedback loop. The method 800 may be run at a continuous interval. Alternatively, the method 800 may iterate through at specified intervals. Alternatively, the method 800 may be triggered to execute by a specific action, for example by a computing device receiving an input video stream, or by a user executing a specific command.

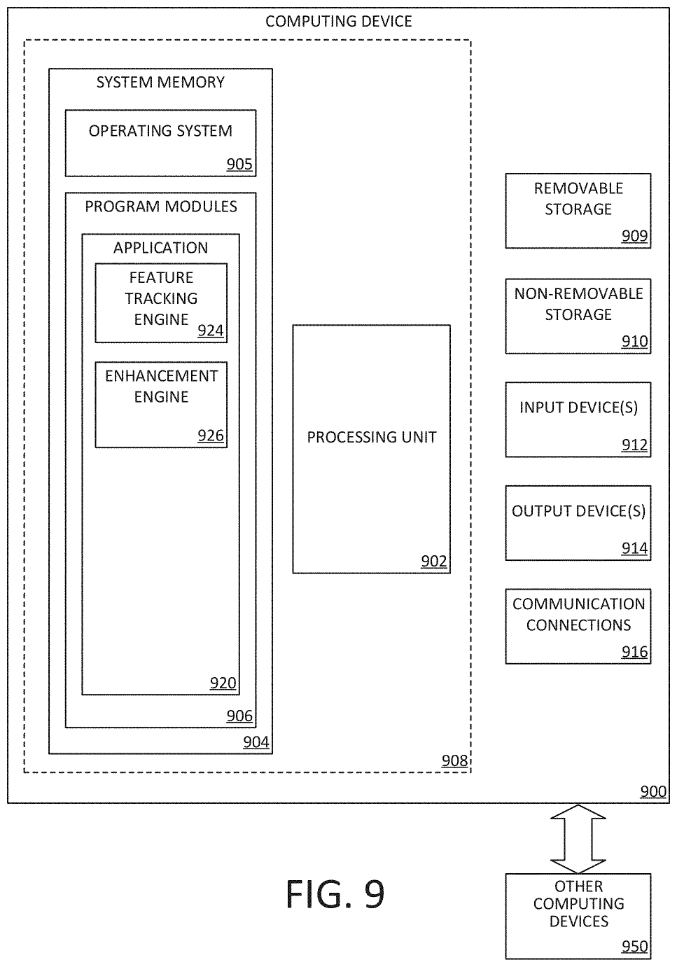

FIGS. 9-12 and the associated descriptions provide a discussion of a variety of operating environments in which aspects of the disclosure may be practiced. However, the devices and systems illustrated and discussed with respect to FIGS. 9-12 are for purposes of example and illustration and are not limiting of a vast number of computing device configurations that may be utilized for practicing aspects of the disclosure, described herein.

FIG. 9 is a block diagram illustrating physical components (e.g., hardware) of a computing device 900 with which aspects of the disclosure may be practiced. The computing device components described below may be suitable for the computing devices described above, including computing device 102 in FIG. 1. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories.

The system memory 904 may include an operating system 905 and one or more program modules 906 suitable for running software application 920, such as one or more components supported by the systems described herein. As examples, system memory 904 may store feature tracking engine 924 and enhancement engine 926. The operating system 905, for example, may be suitable for controlling the operation of the computing device 900.

Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., application 920) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

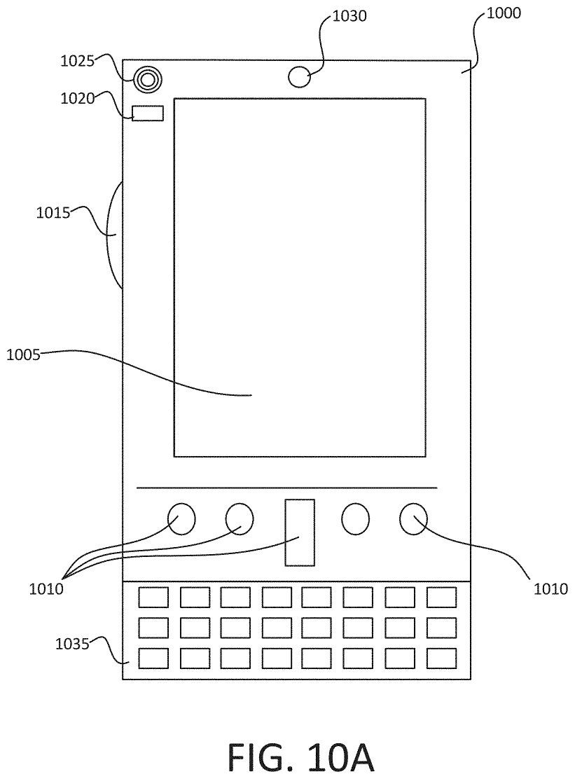

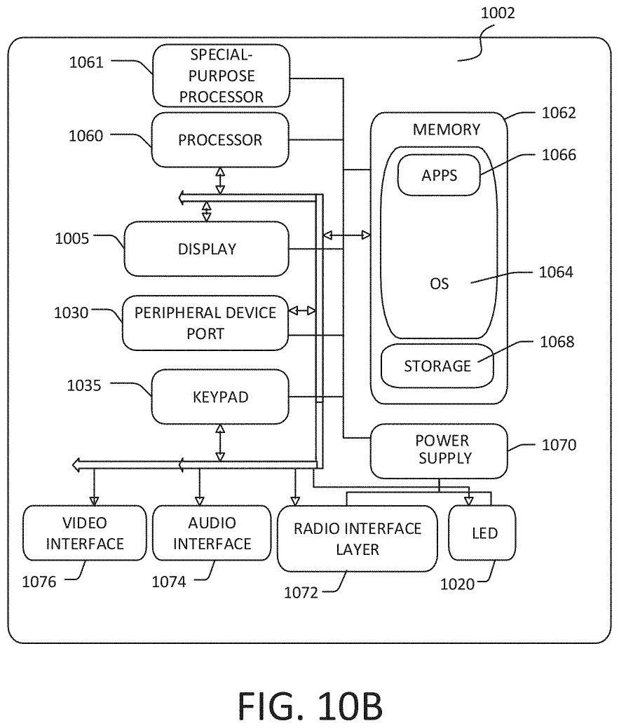

FIGS. 10A and 10B illustrate a mobile computing device 1000, for example, a mobile telephone, a smart phone, wearable computer (such as a smart watch), a tablet computer, a laptop computer, and the like, with which some aspects of the disclosure may be practiced. In some aspects, the client may be a mobile computing device. With reference to FIG. 10A, one aspect of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display).

If included, an optional side input element 1015 allows further user input. The side input element 1015 may be a rotary switch, a button, or any other type of manual input element. In alternative aspects, mobile computing device 1000 may incorporate more or less input elements. For example, the display 1005 may not be a touch screen in some examples.

In yet another alternative example, the mobile computing device 1000 is a portable phone system, such as a cellular phone. The mobile computing device 1000 may also include an optional keypad 1035. Optional keypad 1035 may be a physical keypad or a “soft” keypad generated on the touch screen display.

In various examples, the output elements include the display 1005 for showing a graphical user interface (GUI), a visual indicator 1020 (e.g., a light emitting diode), and/or an audio transducer 1025 (e.g., a speaker). In some aspects, the mobile computing device 1000 incorporates a vibration transducer for providing the user with tactile feedback. In yet another aspect, the mobile computing device 1000 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one aspect of a mobile computing device. That is, the mobile computing device 1000 can incorporate a system (e.g., an architecture) 1002 to implement some aspects. In one examples, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein (e.g., a feature tracking engine, an enhancement engine, etc.).

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated example, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and/or special-purpose processor 1061 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with aspects of the present disclosure, the microphone may also serve as an audio sensor to facilitate control of notifications, as will be described below. The system 1002 may further include a video interface 1076 that enables an operation of an on-board camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10B by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

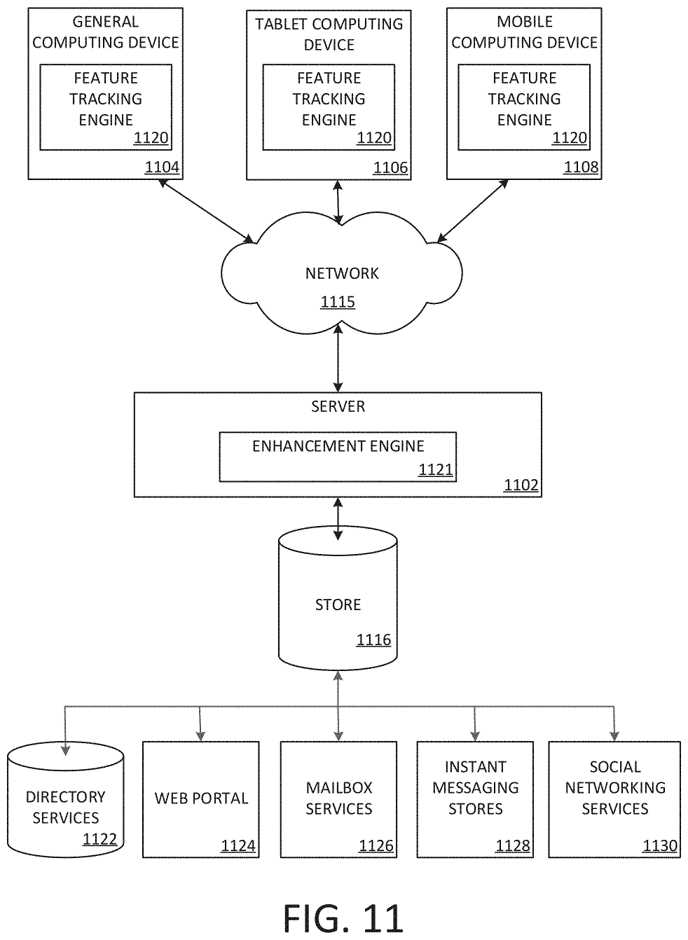

FIG. 11 illustrates one aspect of the architecture of a system for processing data received at a computing system from a remote source, such as a personal computer 1104, tablet computing device 1106, or mobile computing device 1108, as described above. Content displayed at server device 1102 may be stored in different communication channels or other storage types. For example, various documents may be stored using a directory service 1122, a web portal 1124, a mailbox service 1126, an instant messaging store 1128, or a social networking site 1130.

A feature tracking engine 1120 may be employed by a client that communicates with server device 1102, and/or enhancement engine 1121 may be employed by server device 1102. The server device 1102 may provide data to and from a client computing device such as a personal computer 1104, a tablet computing device 1106 and/or a mobile computing device 1108 (e.g., a smart phone) through a network 1115. By way of example, the computer system described above may be embodied in a personal computer 1104, a tablet computing device 1106 and/or a mobile computing device 1108 (e.g., a smart phone). Any of these examples of the computing devices may obtain content from the store 1116, in addition to receiving graphical data useable to be either pre-processed at a graphic-originating system, or post-processed at a receiving computing system.

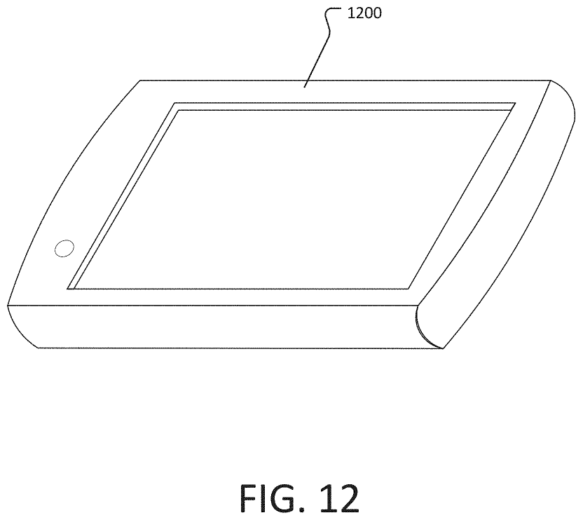

FIG. 12 illustrates an exemplary tablet computing device 1200 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the present disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

In some examples, a system includes at least one processor, and memory storing instructions that, when executed by the at least one processor, cause the system to perform a set of operations. The set of operations include obtaining an input video stream, identifying, within the input video stream, a frame portion containing a subject of interest, enlarging the frame portion containing the subject of interest, enhancing the frame portion of the input video stream to increase fidelity within the frame portion, and displaying the enhanced frame portion.

In some examples, the set of operations further include determining if the frame portion is smaller than a designated threshold. If the frame portion is smaller than the designated threshold, then the frame portion may be enlarged.

In some examples, the frame portion may be digitally enlarged.

In some examples, the enhancing of the frame portion is done by a trained model. The trained model may be trained based on a loss of fidelity between one or more original images and one or more enhanced images. The one or more enhanced images may correspond to the one or more original images.

In some examples, after identifying the frame portion, the set of operations further include generating a transition portion that extends between the enhanced frame portion and an unenhanced portion. Displaying the enhanced frame portion may further include displaying the transition portion, and the unenhanced portion.

In some examples, a loss of fidelity in the transition portion is higher than a loss of fidelity in the enhanced frame portion.

In some examples, the set of operations further includes tracking movements of the subject of interest, and storing, in memory, a record that corresponds to the movements of the subject of interest. The movements may occur over a period of time.

In some examples, the subject of interest is a plurality of subjects of interest. From amongst the plurality of subjects of interest, a focal subject of interest may be identified.

In some examples, the frame portion surrounds the focal subject of interest.

In some examples, the set of operations further include determining if the focal subject of interest is moving, and if the focal subject of interest is moving, translating the enhanced frame portion across a display screen, based on a movement of the focal subject of interest.

In some examples, a method for video stream refinement of a dynamic scene is disclosed. The method includes receiving an input video stream, identifying, within the input video stream, a subject of interest, generating a subject frame around the subject of interest, identifying, within the input video stream, a feature of interest that corresponds to the subject of interest, generating a feature frame around the feature of interest, enlarging the feature frame, enhancing the input video stream within the feature frame, to increase the fidelity within the feature frame, and displaying the feature frame.

In some examples, after enlarging the feature frame, the feature frame is enhanced, and displaying the feature frame may include displaying the enhanced feature frame.

In some examples, the method further include training a model to enhance the feature frame. The training may be based on a loss of fidelity between one or more original images and one or more enhanced images that correspond to the original images.

In some examples, the model is a machine learning model.

In some examples, the subject of interest is one or more persons, one or more animals, or one or more objects.

In some examples, when the subject of interest is a person, the feature of interest is a head of the person, or hands of the person.

In some examples, a system includes at least one processor, and memory storing instructions that, when executed by the at least one processor, cause the system to perform a set of operations. The set of operations include receiving an input video stream, identifying, within the input video stream, a frame portion containing a subject of interest, enhancing the frame portion of the input video stream, and displaying the enhanced frame portion moving across a display screen. The enhanced frame portion may move based on a movement of the subject of interest.

In some examples, the subject of interest is a plurality of subjects of interest. The focal subject of interest is identified from amongst the plurality of subjects of interest. The frame portion containing the focal subject of interest and the enhanced frame portion move based on the movement of the focal subject of interest.

In some examples, the focal subject of interest is a person.

In some examples, the input video stream is obtained from a video data source.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
obtaining an input video stream;
identifying, within the input video stream, a frame portion containing a subject of interest;
enlarging the frame portion containing the subject of interest;
enhancing the frame portion of the input video stream to increase fidelity within the frame portion; and
displaying the enhanced frame portion.

2. The system of claim 1, wherein the set of operations further comprise:
determining if the frame portion is smaller than a designated threshold,
wherein, if the frame portion is smaller than the designated threshold, then the frame portion is enlarged.

3. The system of claim 2, wherein the frame portion is digitally enlarged.

4. The system of claim 1, wherein the enhancing of the frame portion is done by a trained model, and wherein the trained model is trained based on a loss of fidelity between one or more original images and one or more enhanced images, the one or more enhanced images corresponding to the one or more original images

5. The system of claim 4, wherein, after identifying the frame portion, the set of operations further comprises generating a transition portion extending between the enhanced frame portion and an unenhanced portion, wherein displaying the enhanced frame portion further comprises displaying the transition portion, and the unenhanced portion.

6. The system of claim 5, wherein a loss of fidelity in the transition portion is higher than a loss of fidelity in the enhanced frame portion.

7. The system of claim 1, wherein the set of operations further comprises:
tracking, movements of the subject of interest; and
storing, in memory, a record corresponding to the movements of the subject of interest, the movements occurring over a period of time.

8. The system of claim 1, wherein the subject of interest is a plurality of subjects of interest, and wherein from amongst the plurality of subjects of interest, a focal subject of interest is identified.

9. The system of claim 8, wherein the frame portions surrounds the focal subject of interest.

10. The system of claim 9, wherein the set of operations further comprise:
determining if the focal subject of interest is moving; and
if the focal subject of interest is moving, translating the enhanced frame portion across a display screen, based on a movement of the focal subject of interest.

11. A method for video stream refinement of a dynamic scene, the method comprising:
receiving an input video stream;
identifying, within the input video stream, a subject of interest;
generating a subject frame around the subject of interest;
identifying, within the input video stream, a feature of interest that corresponds to the subject of interest;
generating a feature frame around the feature of interest;
enlarging the feature frame;
enhancing the input video stream, within the feature frame, to increase fidelity within the feature frame; and
displaying the feature frame.

12. The method of claim 11, wherein after enlarging the feature frame, the feature frame is enhanced, and displaying the feature frame comprises displaying the enhanced feature frame.

13. The method of claim 12, further comprising:
training a model to enhance the feature frame, wherein the training is based on a loss of fidelity between one or more original images and one or more enhanced images that correspond to the original images.

14. The method of claim 13, wherein the model is a machine learning model.

15. The method of claim 13, wherein the subject of interest is one or more persons, one or more animals, or one or more objects.

16. The method of claim 15, wherein, when the subject of interest is a person, the feature of interest is a head of the person, or hands of the person.

17. A system comprising:
at least one processor; and
memory storing instructions that, when executed by the at least one processor, causes the system to perform a set of operations, the set of operations comprising:
receiving an input video stream;
identifying, within the input video stream, a frame portion containing a subject of interest;
enhancing the frame portion of the input video stream; and
displaying the enhanced frame portion moving across a display screen, the enhanced frame portion moving based on a movement of the subject of interest.

18. The system of claim 17, wherein the subject of interest is plurality of subjects of interest, and wherein a focal subject of interest is identified from amongst the plurality of subjects of interest, the frame portion containing the focal subject of interest, and the enhanced frame portion moving based on the movement of the focal subject of interest.

19. The system of claim 18, wherein the focal subject of interest is a person.

20. The system of claim 17, wherein the input video stream is obtained from a video data source.
